(19) United States
(12) Patent Application Publication
(10) Pub. No.: US 2025/0376128 A1
(43) Pub. Date: Dec. 11, 2025

(54) VEHICLES AND METHODS FOR VEHICLE IMPACT MITIGATION

(71) Applicant: University of Virginia Patent Foundation, Charlottesville, VA (US)

(72) Inventor: Carl Gregory Shaw, Charlottesville, VA (US)

(21) Appl. No.: 19/230,408

(22) Filed: Jun. 6, 2025

Related U.S. Application Data
(60) Provisional application No. 63/656,703, filed on Jun. 6, 2024.

(51) Int. Cl. B60R 21/0132; B60R 21/01; B60R 21/0134

(52) U.S. Cl. CPC B60R 21/0132; B60R 21/0134; B60R 2021/01013; B60R 2021/01252

(57) ABSTRACT

An autonomous vehicle in various embodiments, comprises a body, at least one releasable component, a decoupling mechanism configured to decouple the at least one releasable component from the body, processing circuitry comprising one or more processors and memory storing computer-executable instructions that, when executed by the one or more processors, cause the one or more processors to perform operations comprising detecting a triggering event and, responsive to detecting the triggering event, causing the decoupling mechanism to decouple the at least one releasable component from the body. In some embodiments, decoupling the at least one releasable component results in a mass reduction of the vehicle, which may, for example, mitigate and impact force between the vehicle and a second object, such as another vehicle. In various embodiments, the triggering event may be an impact, loss of control, or other event.

### CROSS-REFERENCE TO RELATED APPLICATIONS

This application claims the benefit of U.S. Provisional Patent Application Ser. No. 63/656,703, filed Jun. 6, 2024, the disclosure of which is hereby incorporated herein by reference in its entirety.

### TECHNICAL FIELD

The present specification generally relates to vehicles and methods for mitigating damage and/or injury resulting from vehicular collisions or impacts.

### BACKGROUND

Vehicles, such as autonomous driving vehicles (ADVs) for various purposes, are developed to meet various needs, such as delivery of goods, which may not require drivers to maneuver the vehicles, or for situations where occupants are not in the vehicles. Such unmanned vehicles may collide with other vehicles (e.g., vehicles with passengers or drivers; or other unmanned vehicles). Passenger vehicles may require a rigid structure to safeguard occupants such as energy-absorbing crumple zones (e.g., a bumper, a hood, a trunk, or the like). On the other hand, unmanned vehicles (e.g., ADVs or the like) may not require energy-absorbing crumple zones. Also, mass is related to impact force and force is proportional to the potentially injurious force action on occupants. Although advanced sensor and control systems may reduce the chance of a collision between vehicles, efforts are made to explore options for reducing impact to the vehicles in the event of a collision. Accordingly, a mechanism for reducing the vehicular mass engaged in an impact may be desired.

### SUMMARY

In accordance with the purpose(s) of the present disclosure, as embodied and broadly described herein, the disclosure, in one aspect, relates to a vehicle impact mitigation device, system and related methods thereof. Various embodiments can include vehicle devices, systems, and related methods that mitigate damage and other negative effects of vehicles impacts as desired or required.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure. In addition, all optional and preferred features and modifications of the described embodiments are usable in all aspects of the disclosure taught herein.

An autonomous vehicle, according to particular embodiments, comprise: (1) a body; (2) at least one releasable component; (3) a decoupling mechanism configured to decouple the at least one releasable component from the body; and (4) processing circuitry comprising one or more processors and memory storing computer-executable instructions that, when executed by the one or more processors, cause the one or more processors to perform operations comprising: (1) detecting a triggering event; and (2) responsive to detecting the triggering event, causing the decoupling mechanism to decouple the at least one releasable component from the body.

In some embodiments, decoupling the at least one releasable component from the body comprises decoupling the at least one releasable component from the body according to a set of decoupling parameters defined by the triggering event. In various embodiments, the set of decoupling parameters comprise at least one of a timing of the detected triggering event or a velocity of the vehicle with respect to a second object identified with the triggering event. In some embodiments, the decoupling mechanism comprises at least one of a passive decoupling mechanism or an active decoupling mechanism. In particular embodiments, the decoupling mechanism comprises at least one of a pyrotechnic separation bolt, an electric actuating mechanism, a magnetic actuating mechanism, a gas actuating mechanism, or a thermal actuating mechanism.

In particular embodiments, the triggering event comprises at least one of an impact, a potential impact, a collision, a loss of traction, or a loss of contact between a tire of the vehicle and a support surface. In various embodiments, causing the decoupling mechanism to decouple the at least one releasable component from the body occurs prior to the triggering event.

A method, according to some embodiments, comprise: (1) detecting, by computing hardware, a triggering event for an autonomous vehicle, the autonomous vehicle comprising a body, a set of components, and a set of component coupling mechanisms, wherein each component in the set of components is coupled to the body via at least one respective component coupling mechanism of the set of component coupling mechanisms; (2) responsive to the triggering event, causing, by the computing hardware, a reduction in a mass of the autonomous vehicle by: (1) selecting a subset of the set of components based on the triggering event; (2) identifying the at least one respective component coupling mechanism for each component in the subset of the set of components; (3) determining, for each respective component coupling mechanism, a release process; and (4) initiating, for each respective component coupling mechanism, the release process.

In some embodiments, at least one component in the set of components comprises a vehicle battery. In other embodiments, initiating the release process comprises initiating the release process prior to the triggering event. In particular embodiments, the triggering event comprises at least one of an impact, a potential impact, a collision, a loss of traction, or a loss of contact between a tire of the vehicle and a support surface. In some embodiments, each respective component coupling mechanism comprises at least one a pyrotechnic separation bolt, an electric actuating mechanism, a magnetic actuating mechanism, a gas actuating mechanism, or a thermal actuating mechanism. In particular embodiments, at least one component in the set of components is coupled to the body via at the least one respective component coupling mechanism via at least one biasing mechanism. In some embodiments, initiating the release process comprises initiating the release process for at least a first component coupling mechanism prior to the triggering event and initiating the release process for at least a second component coupling mechanism after the triggering event.

An autonomous vehicle, according to various embodiments, comprises: (1) a body; (2) a mass reduction mechanism; and (3) processing circuitry comprising one or more processors and memory storing computer-executable instructions that, when executed by the one or more processors, cause the one or more processors to perform operations comprising: (A) detecting a triggering event; and (B) responsive to detecting the triggering event, causing the mass reduction mechanism to reduce a mass of the body. In some embodiments, reducing the mass of the body comprises causing the mass reduction mechanism to passively release at least one component coupled to the body. In various embodiments, reducing the mass of the body comprises causing the mass reduction mechanism to actively release at least one component coupled to the body.

In particular embodiments, the triggering event comprises at least one of an impact, a potential impact, a collision, a loss of traction, or a loss of contact between a tire of the vehicle and a support surface. In various embodiments, the mass reduction mechanism comprises at least one of a pyrotechnic separation bolt, an electric actuating mechanism, a magnetic actuating mechanism, a gas actuating mechanism, or a thermal actuating mechanism. In particular embodiments, the mass reduction mechanism comprises a set of decoupling mechanisms, each decoupling mechanism in the set of decoupling mechanisms being configured to decouple a respective vehicle component from the body.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

Drawings are presented in the attachment files accompanying this specification:

FIG. 1 depicts an autonomous vehicle according to various examples of the present disclosure.

FIG. 2 depicts a flowchart illustrating a process for mitigating vehicle impact according to various examples of the present disclosure.

FIG. 3 depicts a flowchart illustrating a process for identifying triggering events in accordance with various embodiments of the present disclosure.

FIG. 4 depicts a flowchart illustrating a process for mitigating an impact of a triggering event in accordance with various embodiments of the present disclosure.

FIG. 5 is a schematic block diagram illustrating a system for identifying triggering events and taking responsive action to mitigate vehicle impacts according to various examples of the present disclosure.

FIGS. 6A-6C depict an impact between a vehicle and a second vehicle in accordance with various embodiments of the present disclosure.

FIGS. 7A-7D depict an exemplary decoupling mechanism in accordance with various aspects of the present disclosure.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the disclosure. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method and/or process can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a component,” “a coupling mechanism,” or “a triggering event,” including, but not limited to, mixtures or combinations of two or more such components, coupling mechanism, triggering events, and the like. Similarly, references to a plurality of a particular components, mechanism, etc. include single referents.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### Overview

As noted above, there is a need for improved systems and mechanisms for reducing the impact of vehicle collisions. The impact reduction may relate, for example, to reduce damaged to involved vehicles, reduced injury to passengers in either an impacted or impacting vehicle, and the like. As such, various embodiments of a vehicle described herein include a mechanism for reducing an impact force on objects in case of collision, loss of vehicle control, loss of traction, and the like. In some examples, a vehicle may include one or more components that are separable and/or removable from the vehicle to reduce the mass of the vehicle. In other examples, the vehicle may be deformable through separation of one or more components from the vehicle. By reducing the mass of the vehicle at, immediately prior to, and/or immediately following impact, an impact force may be reduced with corresponding reduction in vehicular damage and/or injury to occupants. In particular embodiments, a mechanism for reducing the mass may include a separation mechanism configured to release, separate, drop, jettison, eject, or otherwise detach the one or more components from the vehicle.

As may be understood in light of this disclosure, autonomous vehicles may include control systems that utilize one or more sensors or other suitable devices to reduce a chance of collision with another vehicle or object while the autonomous vehicle is traversing a road. Although such control systems continue to improve, reduced incidence of collisions between such autonomous vehicles and other objects (e.g., vehicles, buildings, posts, etc.) may still result in at least some collisions.

Some autonomous vehicles may have requirements that are distinct from certain passenger vehicles. For example, autonomous vehicles may be designed to only carry cargo without carrying passengers. Such autonomous vehicles may have design requirements that differ from passenger vehicles as such vehicles may not be required to consider the safety of a passenger within the vehicle in the case of a collision. Such vehicles may, however, need to interact with other vehicles that do carry passengers. Various embodiments of an autonomous vehicle described herein may provide improved collision results (e.g., in terms of the safety of passengers in a second vehicle that collides with a passenger-less autonomous vehicle through injury reduction, decreased damage to impacts objects with which the autonomous vehicle may inadvertently collide, etc.).

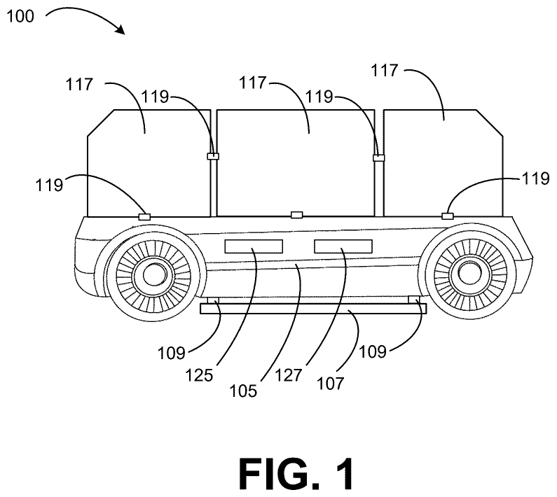

FIG. 1 depicts a vehicle 100 according to particular embodiments. In the embodiment shown in this figure, the vehicle 100 includes a passenger-less, autonomous vehicle comprising a body 105. In some embodiments, the body 105 is configured to house one or more electrical and/or mechanical components that enable the vehicle 100 to drive. For example, the body 105 may house one or more vehicle components such as a transmission, driveshaft, one or more motors, one or more batteries, one or more axles, one or more wheels, and the like. In other embodiments, the vehicle 100 may further include driving components, such as a motor, a controller, a front suspension, a rear suspension, and/or the like.

In particular embodiments, the vehicle 100 comprises one or more sensors 125 (e.g., disposed within the body 105) configured for use in detecting a triggering event. In some embodiments, the vehicle 100 comprises one or more controllers 127 (e.g., disposed within the body 105) configured to receive data from the one or more sensors 125, determine responsive action to take in response to triggering events, initiate the responsive action, and/or the like.

In some embodiments, the vehicle 100 comprises at least one battery pack 107 that is releasably coupled to the body 105 via a battery pack coupling mechanism 109. In other embodiments, each battery pack 107 may be releasably coupled to any other suitable portion of the vehicle 100 (e.g., via at least one respective battery pack coupling mechanism 109). In particular embodiments, the vehicle 100 comprises a plurality of battery pack coupling mechanisms configured to couple the battery pack 107 to the body 105 and maintain the battery pack 107 adjacent the body 105 in a manner suitable to provide electrical power to one or more vehicle components that may require battery power.

In some embodiments, each battery pack coupling mechanism 109 may include any suitable connection and/or separation device or combination of connection and/or separation devices. For example, in some embodiments, each battery pack coupling mechanism 109 may include one or more actuators, one or more fasteners, one or more passive connections systems (e.g., configured to release the battery pack 107 in response to a particular stimulus), one or more active connection systems (e.g., configured to apply a suitable force for releasing the battery pack 107, etc.), and/or the like.

In particular embodiments, each battery pack coupling mechanism 109 may provide active separation, which may be activated in response to a signal from a controller. For example, a particular controller of the one or more controllers 127 may determine when to activate the separation mechanism and activate the separation mechanism in response to the determination. In some embodiments, the controller may activate the separation mechanism in response to detecting the triggering event.

In particular embodiments, the triggering event may include a pre-collision event, an event that occurs prior to a collision between two objects. For example, the one or more controllers 127 may determine the pre-collision event based on a relative location and/or relative velocity of the vehicle 100 with respect to another object (e.g., a rail, a wall, or another vehicle) when a collision is likely to occur between the vehicle and another object. The criteria by which the one or more controllers 127 actuate a triggering event may be customized according to the nature of the vehicle, vehicular velocity, the environment in which it is operating, the size or mass of payload or components, and the characteristics of the other object such as size, shape, orientation, or motion.

In various embodiments, each battery pack coupling mechanism 109 may provide passive separation. Particular embodiments of a separation mechanism that makes up part of each battery pack coupling mechanism 109 for passive separation may, for example, be designed to break the one or more components away at specified criteria, e.g., a threshold force or impact applied to the vehicle. For example, passive separation mechanisms may include frangible connections, such as torque limiters, nylon shear bolts, or the like.

In various embodiments, the battery pack coupling mechanism 109 may include a suitable coupler (e.g., a hook, a latch, or the like) that couples the battery pack 107 to the body 105 or other suitable portion of the vehicle 100. The coupler, in various embodiments, may passively separate the one or more components from the vehicle by disengaging upon or prior to impact, or the coupler may actively separate the one or more components from the vehicle by an actuator for the coupler that actuates the coupler to disengage the one or more components form the vehicle in response to the triggering event.

In particular embodiments, the battery pack coupling mechanism 109 may further include a biasing element that may be disposed between the battery pack 107 and the vehicle 100 and that may bias the battery pack 107 away from the vehicle 100 upon separation. For example, the biasing element may in compression when the battery pack 107 is coupled to the vehicle 100 and may bias the battery pack 107 away from the vehicle when the separation mechanism is activated. For example, the biasing element may be a spring, a polymer spring, or the like.

In the embodiment shown in FIG. 1, the vehicle 100 includes a single battery pack 107 coupled to the body 105 via a first battery pack coupling mechanism 109 and a second battery pack coupling mechanism 109. In other embodiments, the vehicle 100 may include any suitable number of batteries, battery packs, etc. In still other embodiments, each respective battery and/or battery pack may be at least temporarily coupled to the vehicle 100 via any suitable number of coupling mechanisms.

In various embodiments, the vehicle 100 further comprises one or more components 117. As may be understood from FIG. 1, each of the one or more components 117 are coupled (e.g., selectively coupled) to the body 105 (e.g., or other suitable portion of the body 105) via one or more component coupling mechanisms 119. As may be understood in light of this disclosure, each of the components 117 may include any suitable component, such as a cargo module, vehicle portion, drivetrain, motor, and/or the like. In some embodiments, each of the component coupling mechanisms 119 may include, for example at least one of a pyrotechnic separation bolt, an electric actuating mechanism, a magnetic actuating mechanism, a gas actuating mechanism, a thermal actuating mechanism, or the like. In some embodiments, the pyrotechnic separation bolt comprises an explosive bolt.

In some embodiments, each of the component coupling mechanisms 119 may include any suitable connection and/or separation device or combination of connection and/or separation devices. For example, in some embodiment, each of the component coupling mechanisms 119 may include one or more actuators, one or more fasteners, one or more passive connections systems (e.g., configured to release one or more of the components 117 in response to a particular stimulus), one or more active connection systems (e.g., configured to apply a suitable force for releasing the one or more of the components 117, etc.), and/or the like.

In particular embodiments, each of the component coupling mechanisms 119 may provide active separation, which may be activated in response to a signal from a controller. For example, a particular controller of the one or more controllers 127 may determine when to activate the separation mechanism and activate the separation mechanism in response to the determination. In some embodiments, the controller may activate the separation mechanism in response to detecting the triggering event.

In particular embodiments, the triggering event may include a pre-collision event, an event that occurs prior to a collision between two objects. For example, the one or more controllers 127 may determine the pre-collision event based on a relative location and/or relative velocity of the vehicle 100 with respect to another object (e.g., a rail, a wall, or another vehicle) when a collision is likely to occur between the vehicle and another object. The criteria by which the one or more controllers 127 actuate a triggering event may be customized according to the nature of the vehicle, vehicular velocity, the environment in which it is operating, the size or mass of payload or components, and the characteristics of the other object such as size, shape, orientation, or motion.

In various embodiments, each of the component coupling mechanisms 119 may provide passive separation. Particular embodiments of a separation mechanism that makes up part of each of the component coupling mechanisms 119 for passive separation may, for example, be designed to break the one or more components away at specified criteria, e.g., a threshold force or impact applied to the vehicle. For example, passive separation mechanisms may include frangible connections, such as torque limiters, nylon shear bolts, or the like.

In various embodiments, each of the component coupling mechanisms 119 may include a suitable coupler (e.g., a hook, a latch, or the like) that couples one or more of the components 117 to the body 105 or other suitable portion of the vehicle 100. The coupler, in various embodiments, may passively separate the one or more components from the vehicle by disengaging upon or prior to impact, or the coupler may actively separate the one or more components from the vehicle by an actuator for the coupler that actuates the coupler to disengage the one or more components form the vehicle in response to the triggering event.

In particular embodiment, each of the component coupling mechanisms 119 may further include a biasing element that may be disposed between the components 117 and the vehicle 100 and that may bias the components 117 away from the vehicle 100 upon separation. For example, the biasing element may in compression when each of the components 117 are coupled to the vehicle 100 and may bias a respective one of the components 117 away from the vehicle when the separation mechanism is activated. For example, the biasing element may be a spring, a polymer spring, or the like.

In the embodiment shown in FIG. 1, the vehicle 100 includes a set of components 117 coupled to the body 105 via respective component coupling mechanisms 119. In other embodiments, the vehicle 100 may include any suitable number of cargo module or other components that are respectively (e.g., individually) coupled to the vehicle 100 via any suitable number of coupling mechanisms.

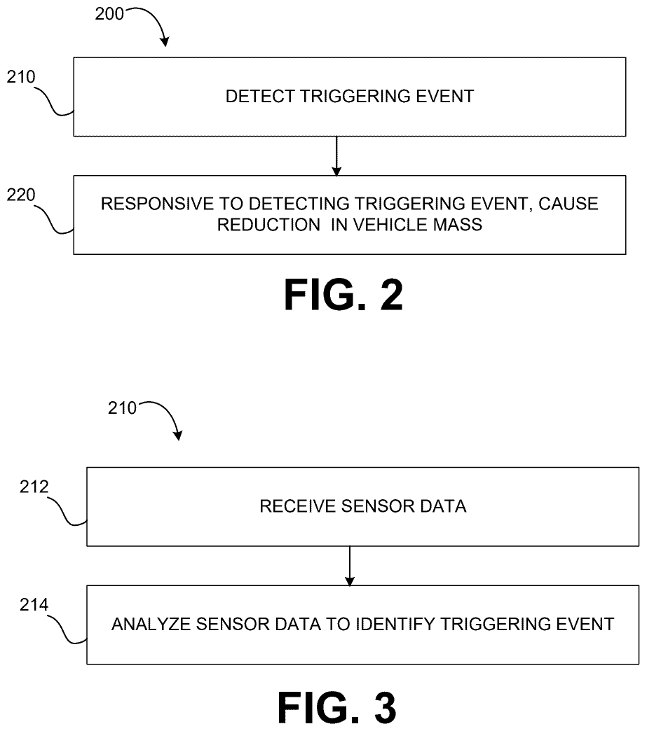

Turning to FIG. 2, a flowchart illustrating a process 200 for reducing a vehicle mass in response to a triggering event is shown. In some examples, the process includes, at step 210, detecting a triggering event. In various embodiments, detecting the triggering event includes identifying an event that requires a responsive action to reduce an amount of damage caused by a vehicle collision (e.g., a collision of a vehicle 100 with a second, potentially vehicle that potentially has passengers). In various embodiments, at step 220, the process includes causing reduction in vehicle mass in response to detecting the triggering event. In some embodiments, reducing the vehicle mass may include any suitable mass reduction techniques describe herein.

For example, in various embodiments, the process involves reducing the vehicle mass by causing any particular battery pack coupling mechanism 109 or any one of the component coupling mechanisms 119 to decouple a battery pack 107 or any one of the components 117 form the vehicle. In some embodiments, causing the reduction in vehicle mass occurs prior to a collision event. In other embodiments, the reduction in vehicle mass occurs during or following the collision event.

Turning to FIG. 3, additional detail is shown regarding a process for detecting a triggering event at step 210 of the process shown in FIG. 2. In various aspects, detecting a triggering event 210 includes, at step 212, receiving sensor data. As discussed herein, a vehicle 100 may include one or more sensors 125 configured to receive data regarding a vehicle 100 and its surroundings during driving. In some embodiments, the one or more sensors 125 may include any suitable imaging device, SONAR device, LiDAR, and/or the like. In various embodiments, the sensor data may include position data (e.g., relative positioning data regarding the vehicle 100 and any surrounding object, whether moving or stationary), relative velocity data (e.g., regarding the vehicle 100 and any surrounding object, whether moving or stationary), acceleration data for the vehicle 100, and/or the like.

At step 214, the process shown in FIG. 3 includes analyzing the sensor data to identify the triggering event. The process may, for example, involve analyzing position, velocity, and other data to determine that a triggering event is about to or is likely to occur. In some embodiments, the process involves determining that a triggering event is likely to occur with at least a particular level of certainty (e.g., at least about 75%, at least about 80%, etc.). In particular embodiments, the triggering event includes a collision event (e.g., between the vehicle 100 and at least one other object, such as another vehicle, a fixed object, etc.). In some embodiments, the triggering event occurs detail regarding an expected impact location (e.g., on the vehicle 100), expected impact force (e.g., relative velocity, acceleration, etc. of the vehicle 100 and the object with which it is expected to collide, etc.).

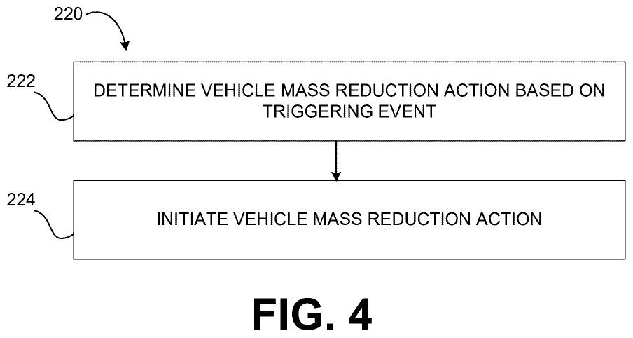

Turning to FIG. 4, additional detail is shown regarding the process for causing reduction in the vehicle mass at step 220 of the process shown in FIG. 2. As may understood from FIG. 4, reducing the vehicle mass includes, at step 222, determining a vehicle mass reduction action based on the triggering event. In some embodiments, the vehicle mass reduction action is based on a type of the triggering event (e.g., collision, impact, rollover, loss of traction, detected tire slipping, vehicle component failure, etc.). In other embodiments, the vehicle mass reduction action is based on detail related to the triggering event. For example, the vehicle mass reduction action may differ based on a type of identified object (e.g., other vehicle, fixed object, wall, sign, pole, etc.) with which the vehicle 100 is expected to collide/impact. In some embodiments, the system is configured to select a particular subset of components based on the particular triggering event.

In some embodiments, determining the vehicle mass reduction action includes: (1) identifying a set of the components 117 that are currently coupled to the vehicle 100; (2) selecting a subset of the set of components 117 that are currently coupled to the vehicle 100 based on the triggering event and/or details related to the triggering event; (3) identifying a set of component coupling mechanisms 119 that are coupling each component in the subset of components 117 to the vehicle 100; (4) determining, for each set of component coupling mechanisms 119 that are coupling each component in the subset of components 117 to the vehicle 100, a release mechanism (e.g., a mechanism for causing each set of component coupling mechanisms 119 to release its corresponding components 117).

At step 224, the process of FIG. 4 further involves initiating the vehicle mass reduction action (e.g., set of vehicle mass reduction actions). This may involve, for example, causing each set of component coupling mechanisms 119 (e.g., or each battery pack coupling mechanism 109) that are coupling each component in the subset of components 117 (e.g., or the battery pack 107) to the vehicle 100 to release each component in the subset of components 117 (e.g., or the battery pack 107) from the vehicle 100. In various embodiments, releasing each component may involve passively releasing the component, activating an actuator or other active release mechanism, etc.

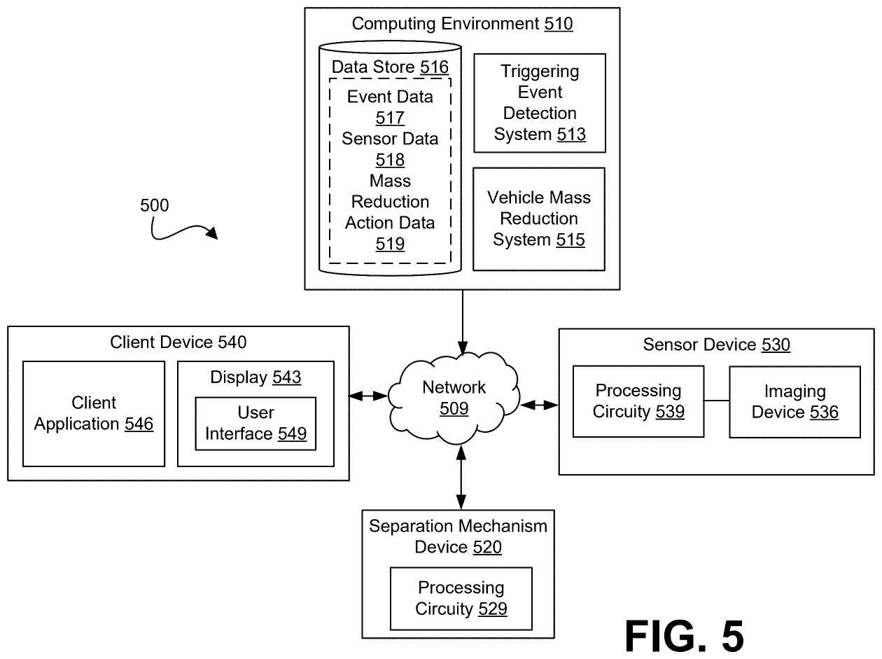

With reference to FIG. 5, shown is a network environment 500 according to various examples. The network environment 500 includes a computing environment 510 that includes a triggering event detection system 513 and a vehicle mass reduction system 515, a separation mechanism device 520, a sensor device 530, and a client device 540, which can be in data communication with each other via a network 509.

The network 509 can include wide area networks (WANs), local area networks (LANs), personal area networks (PANs), or a combination thereof. These networks can include wired or wireless components or a combination thereof. The network 509 can also include a combination of two or more networks 509. Examples of networks 509 can include the Internet, intranets, extranets, virtual private networks (VPNs), and similar networks.

The computing environment 510 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 510 can employ a plurality of computing devices that can be arranged in one or more server banks or computer banks or other arrangements. Such computing devices can be located in a single installation or can be distributed among many different geographical locations. For example, the computing environment 510 can include a plurality of computing devices that together can include a hosted computing resource, a grid computing resource or any other distributed computing arrangement. In some cases, the computing environment 510 can correspond to an elastic computing resource where the allotted capacity of processing, network, storage, or other computing-related resources can vary over time.

Various applications or other functionality can be executed in the computing environment 510. Also, various data is stored in a data store 516 that is accessible to the computing environment 510. The data store 516 can be representative of a plurality of data stores 516, which can include relational databases or non-relational databases such as object-oriented databases, hierarchical databases, hash tables or similar key-value data stores, as well as other data storage applications or data structures. The data stored in the data store 516 is associated with the operation of the various applications or functional entities described below. This data can include event data 517, sensor data 518, mass reduction action data 519, and potentially other data.

Event data 517, in some examples, is representative of triggering events that might warrant responsive actions by the system. For example, the event data may include data related to specific event parameters that may trigger a determination (and execution of one or more steps toward) a corrective action or set of corrective actions.

In some examples, the sensor data 518 is representative of readings from the one or more sensors 125 on the vehicle 100. The system may, for example, store the sensor data 518 for use in identifying potential triggering events (e.g., by the triggering event detection system 513).

In particular examples, the mass reduction action data 519 is representative of a set of potential mass reduction actions to take in response to particular types of triggering events under particular sets of conditions. For examples, the mass reduction action data 519 may identify particular component coupling mechanisms 119 that couple particular components 117 to the vehicle 100. The mass reduction action data 519 may further identify particular components 117 to decouple, and/or release from the vehicle 100 for particular triggering events. In this way, the data store 516 may store data usable by the system to identify triggering events, determine an appropriate set of actions to take in response, and initiate that set of actions in a manner to sufficiently reduce or mitigate damage or other negative consequences resulting from the triggering event.

The systems executed on the computing environment 510, for example, can include a triggering event detection system 513, a vehicle mass reduction system 515, and other applications, services, processes, system, engine, or functionality not discussed in detail herein. The triggering event detection system 513 is executed to detect triggering events that may require corrective action. The triggering event detection system 513 may receive data from the one or more sensors and analyze the data to identify potential triggering events (e.g., impacts).

The vehicle mass reduction system 515 is executed to identify particular components to release, remove, jettison, or otherwise eliminate from the mass of the vehicle 100 prior to, during, and/or immediately following a triggering event such as a collision or impact. The vehicle mass reduction system 515 may, for example, identify specific coupling mechanisms for specific components to be released, and cause those coupling mechanisms to release those specific components based on a time and type of a triggering event.

The separation mechanism device 520 can include processing circuitry 529 that controls operation of one or more components of the battery pack coupling mechanism 109 and/or component coupling mechanisms 119. In this way, the processing circuitry 529 can initiate release of various vehicle components through operation of the battery pack coupling mechanism 109 and/or component coupling mechanisms 119. The processing circuitry 529 can comprise a processor and memory or other circuitry as needed.

The sensor device 530 can include processing circuitry 539 and an imaging device 539. The processing circuitry 539 can comprise a processor and memory or other circuitry as needed. In some examples, the processing circuitry 539 can analyze one or more images captured by the imaging device 536 to identify a triggering event. In some examples, the processing circuitry can transmit imaging data captured by the imaging device 536 to a remote processor for analysis. In still other examples, the sensor device 530 may include any suitable sensor having any suitable components or processing circuitry 539.

A client device 540 is representative of a plurality of client devices that can be coupled to the network 509. The client device 540, in some examples, includes a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, and similar devices), an on-board computer in a vehicle, or other devices with like capability. The client device 540 can include one or more displays 543 such as liquid crystal displays (LCDs), gas plasma-based flat panel displays, organic light emitting diode (OLED) displays, electrophoretic ink (“E-ink”) displays, projectors, or other types of display devices. In some instances, the display 543 can be a component of the client device 540 or can be connected to the client device 540 through a wired or wireless connection.

The client device 540 can be configured to execute various applications such as a client application 546 or other applications. The client application 546 can be executed in a client device 540 to access network content served up by the computing environment 510 or other servers, thereby rendering a user interface 549 on the display 543. For example, the client device 540 can access the data store 516 to provide and configure a set of actions for the vehicle mass reduction system 515 to take in response to identifying particular triggering events. To this end, the client application 546 includes a browser, a dedicated application, or other executable, and the user interface 549 can include a network page, an application screen, or other user mechanism for obtaining user input. In some examples, the client device 540 is configured to execute applications beyond the client application 546 such as email applications, social networking applications, word processors, spreadsheets, or other applications.

In various examples, any individual component shown in the network environment 500 performs any suitable step of the various processes described herein, either individual or in combination with any other component.

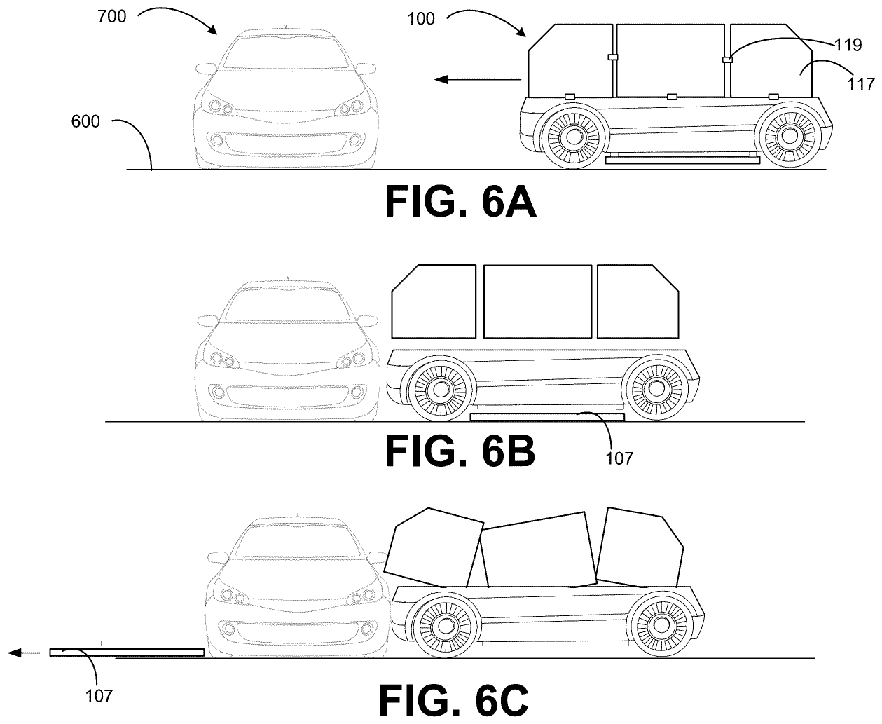

Turning to FIGS. 6A-C, a vehicle 100 is shown impacting a second vehicle 700 while travelling along a support surface 600. As shown in this figure, the impact in this instance may include the type of triggering event discussed herein. In this example, various vehicle components 117 are released (through operation of respective component coupling mechanisms 119) prior to the impact. Additionally, the battery pack 107 is released prior to impact. Following the impact, as shown in FIG. 6C, the battery pack 107 is carried, via momentum, underneath and past the second vehicle 700. The various components 117, having decoupled prior to impact, disperse, having had their mass removed from the vehicle 100 prior to impact, and reducing a force of the impact accordingly.

In various embodiments, the components may be separated from the vehicle before, after, or concurrently with an impact on or collision with the vehicle. Depending on the timing when the components are separated from the vehicle, the impact is reduced to varying degrees.

The amount of displacement of the other vehicle from its initial position may correspond to the amount of the impact force that was applied to the other vehicle. The separation of the components may reduce the impact on the other vehicle. In some embodiments, the amount of the impact reduced from the separation of the components is greater when the components are separated before the impact than when the components are separated at impact or after the impact.

In particular embodiments, some or all of the one or more vehicular components may be separated from the vehicle. FIGS. 6A-6C depict an example that shows that all of the components are separated from the vehicle. For another example, only one or more of the cargo modules may be separated from the vehicle. For yet another example, only the battery pack may be separated from the vehicle 100.

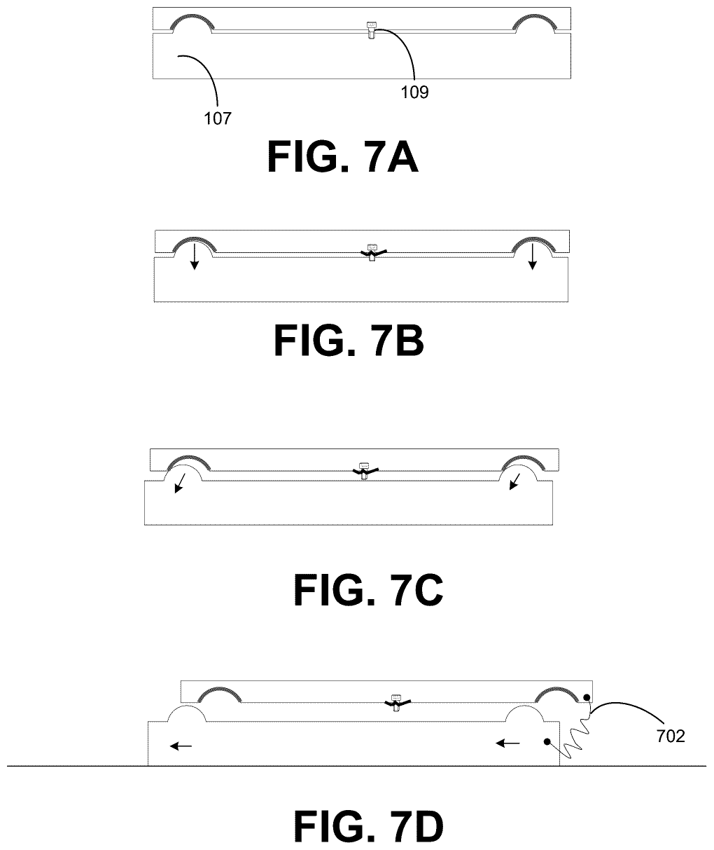

FIGS. 7A-7D depict a battery pack 107 coupled to the body of a vehicle via a battery pack coupling mechanism 109 (in this case, a pyrotechnic bolt). The battery pack 107 is further coupled via a hemispherical compression joint comprising a spring polymer. Such a design may reduce a number of release fasteners required while providing damped positive location geometry via the hemispherical joints. Once the battery pack coupling mechanism 109 disengages the battery pack 107 from the body, the spring polymer biases the battery pack 107 dome downward as shown in FIGS. 7B-7C. The battery pack 107, disengaged from the frame, may slide along a support surface once the frame impacts another object (e.g., vehicle). In some embodiments, the battery pack 107 may be tethered to the body via a suitable tether 702.

Although the flowcharts herein show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some examples, one or more of the blocks shown in the diagram can be skipped or omitted. It is understood that all such variations are within the scope of the present disclosure.

In the present disclosure, disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

It should be emphasized that the above-described examples of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

What is claimed is:

1. An autonomous vehicle comprising:
a body;
at least one releasable component;
a decoupling mechanism configured to decouple the at least one releasable component from the body; and
processing circuitry comprising one or more processors and memory storing computer-executable instructions that, when executed by the one or more processors, cause the one or more processors to perform operations comprising:
detecting a triggering event; and
responsive to detecting the triggering event, causing the decoupling mechanism to decouple the at least one releasable component from the body.

2. The autonomous vehicle of claim 1, wherein decoupling the at least one releasable component from the body comprises decoupling the at least one releasable component from the body according to a set of decoupling parameters defined by the triggering event.

3. The autonomous vehicle of claim 2, wherein the set of decoupling parameters comprise at least one of a timing of the detected triggering event or a velocity of the vehicle with respect to a second object identified with the triggering event.

4. The autonomous vehicle of claim 1, wherein the decoupling mechanism comprises at least one of a passive decoupling mechanism or an active decoupling mechanism.

5. The autonomous vehicle of claim 4, wherein the decoupling mechanism comprises at least one of a pyrotechnic separation bolt, an electric actuating mechanism, a magnetic actuating mechanism, a gas actuating mechanism, or a thermal actuating mechanism.

6. The autonomous vehicle of claim 1, wherein the triggering event comprises at least one of an impact, a potential impact, a collision, a loss of traction, or a loss of contact between a tire of the vehicle and a support surface.

7. The autonomous vehicle of claim 1, wherein causing the decoupling mechanism to decouple the at least one releasable component from the body occurs prior to the triggering event.

8. A method comprising:
detecting, by computing hardware, a triggering event for an autonomous vehicle, the autonomous vehicle comprising a body, a set of components, and a set of component coupling mechanisms, wherein each component in the set of components is coupled to the body via at least one respective component coupling mechanism of the set of component coupling mechanisms;
responsive to the triggering event, causing, by the computing hardware, a reduction in a mass of the autonomous vehicle by:
selecting a subset of the set of components based on the triggering event;
identifying the at least one respective component coupling mechanism for each component in the subset of the set of components;
determining, for each respective component coupling mechanism, a release process; and
initiating, for each respective component coupling mechanism, the release process.

9. The method of claim 8, wherein at least one component in the set of components comprises a vehicle battery.

10. The method of claim 8, wherein initiating the release process comprises initiating the release process prior to the triggering event.

11. The method of claim 8, wherein the triggering event comprises at least one of an impact, a potential impact, a collision, a loss of traction, or a loss of contact between a tire of the vehicle and a support surface.

12. The method of claim 8, wherein each respective component coupling mechanism comprises at least one a pyrotechnic separation bolt, an electric actuating mechanism, a magnetic actuating mechanism, a gas actuating mechanism, or a thermal actuating mechanism.

13. The method of claim 8, wherein at least one component in the set of components is coupled to the body via at the least one respective component coupling mechanism via at least one biasing mechanism.

14. The method of claim 8, wherein initiating the release process comprises initiating the release process for at least a first component coupling mechanism prior to the triggering event and initiating the release process for at least a second component coupling mechanism after the triggering event.

15. An autonomous vehicle comprising:
a body;
a mass reduction mechanism; and
processing circuitry comprising one or more processors and memory storing computer-executable instructions that, when executed by the one or more processors, cause the one or more processors to perform operations comprising:
detecting a triggering event; and
responsive to detecting the triggering event, causing the mass reduction mechanism to reduce a mass of the body.

16. The autonomous vehicle of claim 15, wherein reducing the mass of the body comprises causing the mass reduction mechanism to passively release at least one component coupled to the body.

17. The autonomous vehicle of claim 15, wherein reducing the mass of the body comprises causing the mass reduction mechanism to actively release at least one component coupled to the body.

18. The autonomous vehicle of claim 15, wherein the triggering event comprises at least one of an impact, a potential impact, a collision, a loss of traction, or a loss of contact between a tire of the vehicle and a support surface.

19. The autonomous vehicle of claim 15, wherein the mass reduction mechanism comprises at least one of a pyrotechnic separation bolt, an electric actuating mechanism, a magnetic actuating mechanism, a gas actuating mechanism, or a thermal actuating mechanism.

20. The autonomous vehicle of claim 15, wherein the mass reduction mechanism comprises a set of decoupling mechanisms, each decoupling mechanism in the set of decoupling mechanisms being configured to decouple a respective vehicle component from the body.
